(19) United States
(12) Patent Application Publication
(10) Pub. No.: US 2006/0044107 A1
(43) Pub. Date: Mar. 2, 2006

(54) Biometrically correlated item access method and apparatus

(76) Inventor: Audrius R. Krygeris, Tinley Park, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/927,953

(22) Filed: Aug. 27, 2004

(51) Int. Cl. H04B 1/00; G08C 19/00

(52) U.S. Cl. 340/5.52; 340/5.73

(57) ABSTRACT

A housing can contain a plurality of items. Controlled access to portions of such items occurs in response to biometric information as presented by an authorized individual. In a preferred approach, a first biometric identifier for a given individual correlates to a first kind, level, or degree of dispensation or facilitated access to the plurality of items while a second, different biometric identifier for that same individual correlates to a different kind, level, or degree of dispensation or facilitated access. The housing can comprise, for example, a portable fixture or a fixed-position fixture.

### TECHNICAL FIELD

This invention relates generally to biometrics-based access control.

### BACKGROUND

Biometrics are generally understood to refer to various biological characteristics that tend to be unique from individual to individual. For example, fingerprints and palm prints, retinal and iris patterns, vein/artery layout, DNA, and even odor all tend to vary relatively uniquely from one person to another. Much effort has been placed in recent times on developing inexpensive and reliable mechanisms to facilitate the capture of such biometrics for individuals and to facilitate their subsequent evaluation and comparative study and analysis.

Such interest derives at least in part from a desire to use such unique personal identifiers to facilitate reliable identification of a given individual. For example, such biometrics have been proposed for use as an authentication technique to permit access to facilities and resources of various kinds, including buildings, personal computers, vehicles, weapons, and so forth.

In general, while the mechanisms and techniques employed to permit the capture and analysis of such biometrics information may tend towards the complex, the subsequent use of such information has been more straightforward. Typically, upon confirming someone's identity via one or more of their characterizing biometrics, most such processes then typically just result in a single common response—the vetted individual gains access to some controlled resource or location. That is, if the biometrics-based identification process confirms that a given individual is one who has pre-authorized permission to, for example, enter a given room, then that individual will be permitted to enter the room in question.

In general, while the art of reliably confirming someone's identity on the basis of their biometric characteristics continues to move forward, the use and application of such expertise remains fairly unimaginative and stale.

### BRIEF DESCRIPTION OF THE DRAWINGS

The above needs are at least partially met through provision of the biometrically correlated item access method and apparatus described in the following detailed description, particularly when studied in conjunction with the drawings, wherein:

FIG. 1 comprises a flow diagram as configured in accordance with various embodiments of the invention;

FIG. 2 comprises a schematic view of a hand that illustrates certain aspects that accord with various embodiments of the invention;

FIG. 3 comprises a block diagram as configured in accordance with various embodiments of the invention;

FIG. 4 comprises an exterior schematic view as configured in accordance with various embodiments of the invention; and

FIG. 5 comprises a block diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, a plurality of items can be provided. Biometric information as corresponds to a given individual (which individual has a plurality of biometric features) are then received and used to determine to which of the plurality of biometric features the received biometric information corresponds. Limited access to at least one of the plurality of items (but less than all of the plurality of items) is then provided in a manner that corresponds to the identified biometric feature.

For example, the biometric information may comprise fingerprints. A given individual typically has ten such unique fingerprints. Pursuant to this process, one can identify not only the individual, but also which finger yielded the fingerprint in question. This information, in turn, can be pre-correlated to specific kinds or levels of access to the plurality of items. As one example, a first fingerprint as corresponds to an index finger on the right hand of a given individual can be correlated to the amount of $10 while the ring finger on that same hand of that same individual can be correlated to the amount of $20. So configured, upon assessing whether the index finger or the ring finger has been offered for inspection, this process would facilitate the tendering of a corresponding specific amount of currency to the individual in question.

So configured, access of any kind can of course be restricted to only an authorized person. Beyond this, however, the kind of access provided and/or subsequent facilitated responsive actions can be correlated to and made a function of the particular biometric feature used by the individual. Such an approach offers numerous potential benefits. For example, the user interface itself can be greatly simplified in some cases, as other input devices may not be necessary.

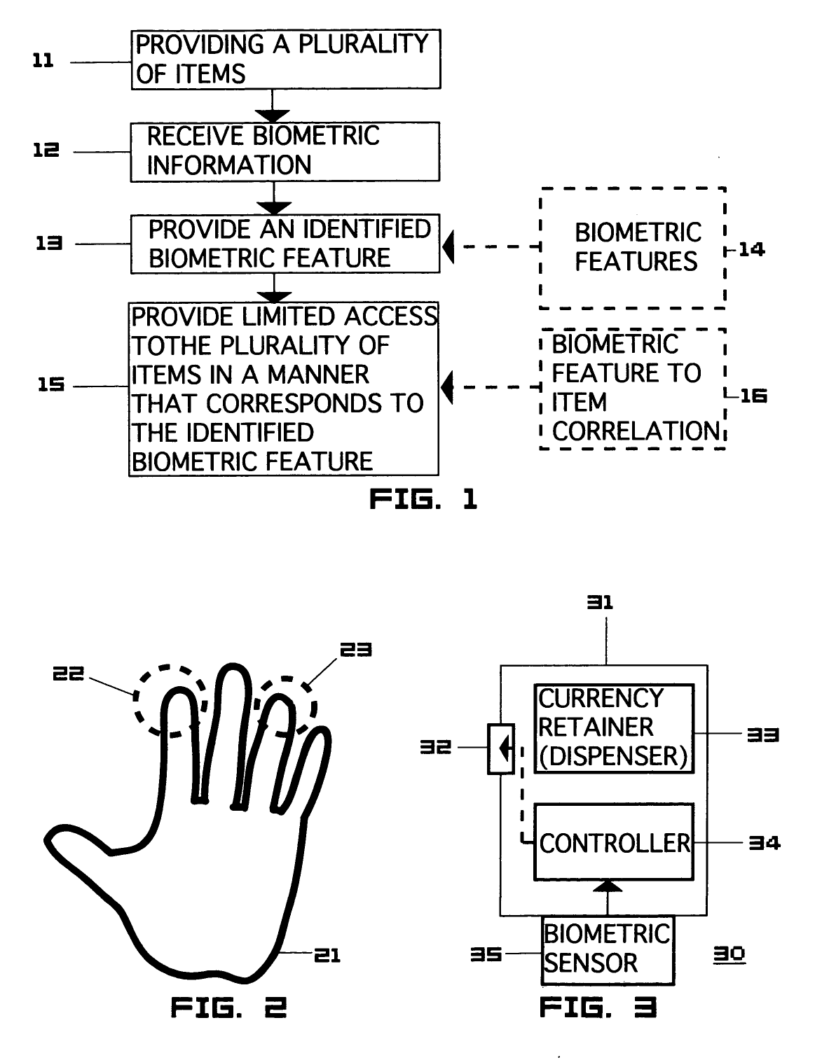

These and other benefits may become clearer upon making a thorough review and study of the following detailed description. Referring now to the drawings, and in particular to FIG. 1, an exemplary process 10 can comprise providing 11 a plurality of items. Pursuant to a preferred embodiment these items can comprise discrete items of currency (such as, for example, $5 bills, $10 bills, $20 bills, and so forth). As will be shown below in more detail, these items are preferably provided in a housing such as a secure portable or fixed-position housing. In any event, pursuant to a preferred approach, access to selected ones of such items is controlled by this process 10 as a function, at least in part, of which biometric characteristic a given individual presents.

This process 10 then provides for reception 12 of biometric information as corresponds to a given individual, which individual has a plurality of biometric features. Such reception 12 may be prompted by a specific request or window of opportunity or, if desired, may be received at essentially any time the individual may so wish as may best accord with the needs and requirements of a given application. As will be described below, typically this step will include translation of the original biometric feature into a corresponding digitized representation thereof in order to better facilitate subsequent processing. The particular biometric information received can be essentially any biometric characteristic and can include, but is not limited to, fingerprints, toeprints, palm prints, retinal patterns, iris patterns, vein and/or artery patterns, ear characteristics, facial features, and the like. This step could also support reception of other biometrics, such as characterizing DNA, but it will likely typically be preferred to avoid the use of biometrics that tend to require invasive sampling to effect their acquisition.

This process 10 then determines which of the plurality of biometric features 14 of this given individual the received biometric information corresponds to, to thereby provide 13 a resultant identified biometric feature. This necessarily goes beyond merely identifying the individual and further comprises identifying which of many biometric features the individual has presented for processing. This can be realized in various ways. Pursuant to one approach, at least an alleged identity of the individual is known a piori and the process 10 limits this processing to consideration of only those biometric features 14 as are known to correspond to that particular individual. Pursuant to another approach, a larger collection of biometric features 14 are used to assess and compare against the received biometric information to thereby permit identification of the individual as well as the specific biometric source itself.

The biometric features 14 are preferably gathered, vetted, and properly processed and stored prior to effecting the present process 10. As an example, all ten fingerprints as are available to the average individual may be sensed, characterized, and stored for such future reference. It will be understood by those skilled in the art that such biometric features 14 could also include a combination of different kinds of biometric features, such as a mixture of fingerprints, retinal patterns, and the like, if so desired.

Those skilled in the art will recognize and understand that there are numerous biometric feature capture, analysis, and comparison techniques already known in the art, and many more will likely be developed in the future. It will further be understood that the present teachings are not particularly sensitive to the selection of any particular one of these techniques or methodologies. Accordingly, for the sake of brevity and the preservation of focus, no further elaboration will be set forth here regarding such techniques except where particularly helpful to the description.

This process 10 then provides 15 limited access to at least one of the plurality items, but usually less than all of the plurality of items, in a manner that corresponds to the identified biometeric feature. This step can be facilitated, for example, by having pre-correlated 16 at least some of the available biometric features to one or more of the plurality of items. For example, this process 10 can be used to provide limited access to specific amounts of currency, which specific amount of currency is less than the total amount of available currency, as corresponds to the identified biometric feature.

As a more specific illustration, and referring momentarily to FIG. 2, when the identified biometric feature corresponds to a first fingerprint for a first specific predetermined finger 22 for a given hand 21 of a given individual, the process 10 can facilitate accessing a first corresponding amount of currency, such as $10. When the identified biometric feature corresponds instead, however, to a another fingerprint for a second specific predetermined finger 23 for that same individual, the process 10 can support instead providing access to a second, different corresponding amount of currency, such as $20.

So configured, it can be seen that these teachings permit, for example, providing currency in a secure housing and then receiving information regarding biometric information for a given individual. When that biometric information comprises first biometric information (such as biometric information that corresponds to a first body part of an individual), the individual has access to a first predetermined amount of the currency. When the biometric information comprises second biometric information, which second biometric information is different than the first biometric information (such as biometric information as corresponds to a second, different body part of the individual), the individual has access to a second predetermined amount of the currency, which second predetermined amount is different than the first predetermined amount.

Those skilled in the art will appreciate that a large number of different correlations can be supported in this manner. As one example, controlled access to ten different amounts of currency can each be correlated to a different fingerprint for the average individual if so desired. It will also be understood that the different “amounts” (whether of currency or some other item or commodity) can differ from one another with respect to individual size (such as, for instance, $10 bills as versus $20 bills) and/or the aggregate number of individual units as are provided (such as, for example, $10 in one dollar bills and $20 in one dollar bills).

Those skilled in the art will also appreciate that data entry values can also be correlated to specific biometric indicators such as fingerprints. For example, given that the average person has ten fingerprints, it may be useful in many applications to at least provide the option of permitting a user to enter data entry values using their fingertips to indicate specific numeric values. For example, by assigning each numeric value from zero to nine to a specific one of the available ten fingers, a user can enter essentially any number by sequentially presenting the corresponding fingerprints. Such an approach could facilitate, for example, permitting a user to input a personal identification number to initialize authorized use of the corresponding apparatus or to input an exact amount of currency to be dispensed. When providing such functionality, it may be helpful to provide a specific switch mechanism to permit a user to toggle the input mechanism as between a data entry mode of operation and other input correlations.

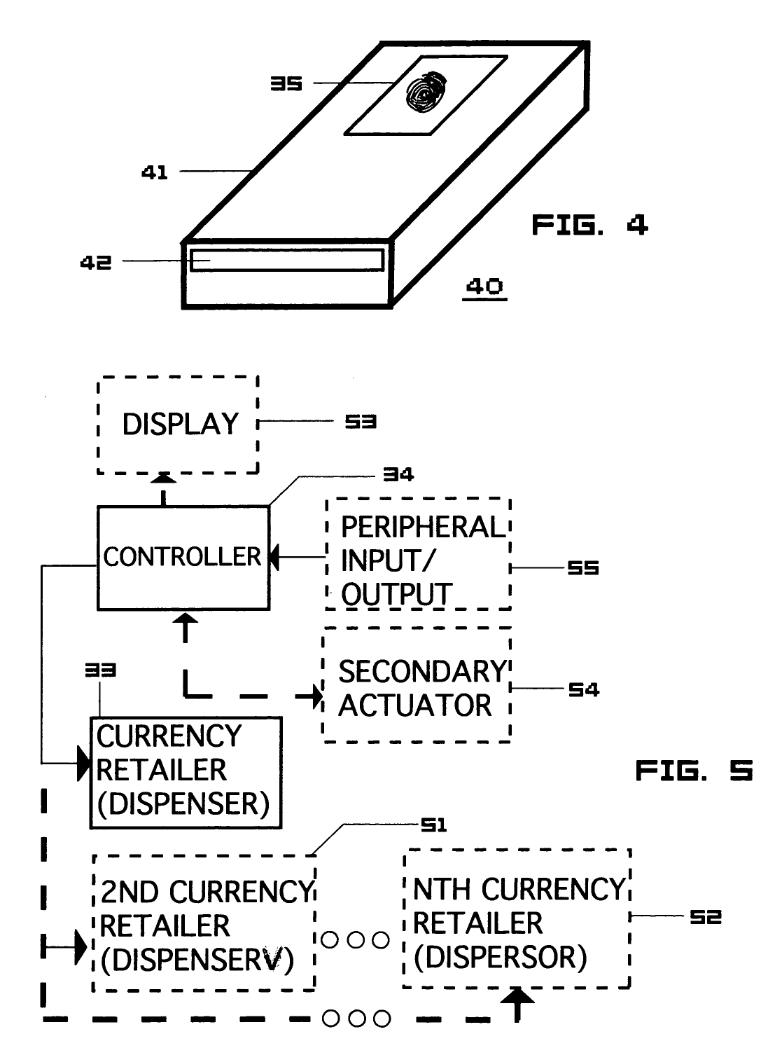

The above-described process(es) can be realized in any of a wide variety of ways. Some illustrative exemplary embodiments will now be presented. Referring to FIG. 3, an enabling apparatus 30 can comprise a housing 31 having at least one opening 32 disposed therethrough. The housing 31 itself can comprise a portable-sized housing (such as a pocket-sized or purse-sized object such as a wallet), a fixed-position housing (such as, for example, an automated teller machine housing, a point-of-sale retail facilitation platform, and the like), or such other sized housing as may best serve the needs of a given application and setting.

In a preferred embodiment the housing 31 comprises a secure enclosure. That is, the housing 31 does not permit ready access to its contents. Various materials and manufacturing techniques are known and are well understood to provide such features and require no further description here.

The opening 32 can comprise either a permanent opening or can comprise a selectably openable/closeable opening, again as may best suit the needs of a given application. For example, for some purposes, it may be acceptable to provide a permanent opening (such as a narrow slot through which currency may be dispensed) because the inner structure and design of the apparatus 30 will otherwise serve to prevent unauthorized access to the dispensable contents of the housing 31. For other purposes, the opening 32 may itself serve as a part of the mechanism that prevents unauthorized access, and in such a case, controllable doors or other movable barriers may comprise a part of the opening 32.

The illustrative example of FIG. 3 depicts only a single such opening 32 for purposes of clarity. It should be understood, however, that any number of openings can be so provided. For example, when the apparatus 30 serves to dispense different amounts of currency in accordance with these teachings, it may be useful to provide a first opening in conjunction with a first dispensing apparatus that dispenses $10 bills and a second opening in conjunction with a second dispensing apparatus that dispenses $20 bills.

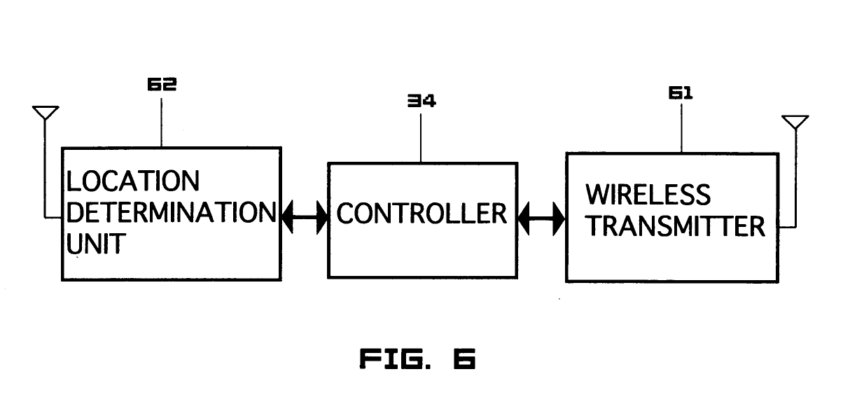

As but one illustrative example, and with momentary reference to FIG. 4, a given wallet-styled version 40 of the apparatus can comprise a pocket-sized housing 41 having a hinged door 42 that selectively occludes, in a secure and controlled fashion, such an opening. So configured, access to the interior of the housing 41 and/or the dispensation of an item such as currency through the opening depends, at least in part, upon the controlled positioning of the door 42. For example, in this illustration, when the hinged door 42 pivots outwardly and upwardly the door 42 will not inhibit or otherwise block egress of currency from within the housing 41. If desired, the housing 41 can be comprised of waterproof or water resistant materials (such as, for example, various plastics) and waterproof (or water resistant) gaskets and seals can be used to aid in preventing water from entering in an unwanted manner around the edges of the door 42. It may also be useful in some settings to construct the apparatus as a buoyant object such that the apparatus will tend to float in water.

Referring again to FIG. 3, and presuming for purpose of explanation that this apparatus 30 indeed serves the purpose of dispensing currency, this embodiment further comprises a currency retainer 33 that is disposed within the housing 31 to thereby aid in preventing unauthorized access thereto. In this simple example, the apparatus 30 has only a single such currency retainer 33 that serves to dispense differing quantities of a given face value of currency (such as differing quantities of $20 bills). Again, depending upon the needs of the application, it may be useful to provide additional such currency retainers to facilitate the dispensation of additional quantities and/or kinds of currency.

If desired, this currency retainer 33 could at least partially comprise a removable inner pouch or other self-sufficient container that could facilitate loading the device with a specific quantity and variety of bills. So configured, upon opening the housing an existing (possibly depleted) pouch could be removed and a fresh pouch could be readily inserted. Optionally, the apparatus could be further configured to include a mechanism to open such a pouch following closure of the housing to secure the pouch therein.

Various kinds of currency retainers and dispensors are known in the art, and therefore additional elaboration will not be provided here for the sake of brevity and clarity.

This embodiment further comprises a controller 34 that operably couples to the currency retainer 33 to control its operation. When the opening 32 includes a movable barrier the controller 34 can also operably couple to that opening 32 mechanism to thereby facilitate control over the actions of the movable barrier. In a preferred embodiment the controller 34 comprises a fully or at least partially programmable platform that can be programmed in accordance with the teachings set forth herein. If desired, of course, a so-called hardwired or otherwise dedicated-purpose platform can be employed for such purposes.

The apparatus 30 also preferably includes at least one biometric sensor 35 such as, in this illustrative example, an asperity sensor (such as a fingerprint sensor). Various such devices are known in the art and operate on various principles. In general this biometric sensor 35 will preferably be disposed or will at least be exposed on the exterior of the housing 31. If desired (or as may relate to the nature of the sensor itself), however, an interior mounting scheme may be employed where, for example, a movable hatch covering may provide protection for the sensor during non-use. In this embodiment the biometric sensor 35 operably couples to the controller 34 to facilitate the actions and functionality of the controller 34 and hence the dispensation actions of the currency retainer 33 and/or the access-control actions of the opening 32.

Such a configuration will readily support a plurality of controller 34 operating modes. Pursuant to a first mode of operation, the controller 34 will facilitate, for example, dispensation of a first amount of currency from the currency retainer 33 via the opening 32 in response to detection of a first biometric input as sensed via the biometric sensor 35 and dispensation of a second, different amount of currency from the currency retainer 33 via the opening 32 in response to detection of a second biometric input as sensed via the biometric sensor 35, which second biometric input is different from the first biometric input. As noted above, such biometric inputs can correspond to fingerprints as relate to different fingers of a given individual.

Other embellishments and alternative configurations are of course possible. For example, as mentioned above and referring now to FIG. 5, such an apparatus can include a plurality of currency retainers, including the currency retainer 33 mentioned above along with a second currency retainer 51 or more (up to and including an Nth currency retainer 52). It may also be helpful or useful for at least some applications to operably couple the controller 34 to one or more displays 53. Such a display 53 can serve a variety of purposes including, for example, providing information regarding a quantity or associated value of items as are presently retained within the housing, information regarding the identity of persons who are authorized to access such items, information regarding which biometric input correlates with which predetermined dispensation behavior, and any other information as may be useful or potentially useful to provide to a potential user of such an apparatus. It would also be possible, for example, to provide a display such as “Please return to John Doe” or “Please call 555-555-5555” upon detecting a biometric input that did not correspond to an authorized user.

When providing information regarding which biometric input correlates with which predetermined dispensation behavior, it may be useful to provide a display of one or both hands along with indications of which fingers effect which functions. As one illustrative example, with respect to depiction of a right hand, the symbol $1 could be shown proximal to the thumb, the symbol $5 could be shown proximal to the index finger, the symbol $10 could be shown proximal to the middle finger, the symbol $20 could be shown proximal to the ring finger, and the symbol $50 could be shown proximal to the little finger. As another example, when using biometric input to facilitate data input, a similar convention can be utilized to instruct a user as to which fingers correspond to which data entry values. For example, to facilitate entry of the ten basic numerical symbols 0 through 9, the fingers of the left and right hand could be displayed with the numbers 0 through 9 depicted in close proximity to their respective fingers.

It may also be useful in some settings to provide at least one secondary actuator 54. When operably coupled to the controller 34, such a secondary actuator 54 can serve as an alternative mechanism for permitting an individual to communicate with the apparatus. Such a secondary actuator 54 can be used, for example, to temporarily initiate the functionality of the apparatus as is described herein. Or, if desired, such a secondary actuator 54 may be employed to initiate, control, or conclude other functions as may be desired. For example, such a secondary actuator 54 may be useful during a training or learning mode of operation when the apparatus receives specific programming with respect to which biometric characteristics of a given individual are to be correlated with which dispensation actions.

Similarly, it may be useful to provide one or more peripheral input/outputs 55 in communication with the controller 34. Such a peripheral input/output 55 can be essentially any type or form factor of interface including but not limited to electrical conductor-based interfaces (such as RJ-11 compatible interfaces, RJ-45 compatible interfaces, and RS-232 compatible interfaces), optical interfaces (such as infrared-based interfaces), and wireless interfaces such as Bluetooth, 802.11 family wireless local area networks, and so forth, to name a few. This kind of interface capability may more easily facilitate programming of the controller, downloading of biometric information and/or corresponding dispensation actions, and the like. Such an interface may also facilitate diagnostic analysis and various maintenance and/or support activities (such as when a financial institution accesses the apparatus in order to restock the currency reserves of the device).

So configured, currency or essentially any other item (either physical, virtual, or resource-oriented) can be dispensed and/or otherwise rendered accessible in a quantity, amount, or type as corresponds to a particular biometric identifier as presented by a given individual. Various such biometric identifiers for such an individual can be readily correlated to differing specific items and/or quantities of a given item. This in turn provides, in a simplistic and integrated fashion, both a high degree of personal security and specific instructions to the apparatus that reflect a desired action or response from the individual. In many cases the user interface can be implemented with only a biometric sensor. Other user interface embellishments can be added as appropriate to support more complicated and/or extended functionality.

Such a configuration permits, for example, ready implementation of a sealed wallet that dispenses varying amounts of cash depending upon which finger an individual uses to actuate the dispensation process. Using merely the available fingers on a normal right hand, up to five different denominations of bills and/or quantities or combinations of bills can be discretely identified and dispensed in this manner. As but one example, the right hand thumb can indicate a $1 bill, the first finger can indicate a $5 bill, the second finger can indicate a $10 bill, the third finger can indicate a $20 bill, and fourth and last finger can indicate a $50 bill.

In such a case, presenting the first finger to the biometric sensor once will result in a single $5 bill being dispensed. Similarly, presenting the first finger twice in succession will result in two $5 bills being dispensed. (If desired, a minimum amount of time, such as one second, can be required between accepting such inputs in order to avoid potential false triggering.)

Such an approach, in turn, permits new ways of interacting with one's personal cash reserves. For example, an individual can reach into their pocket or purse, and without actually viewing the apparatus or subjecting it to the view of others, readily extract a desired amount of currency by simply using the proper finger. As another example, a parent could provide their child with a quantity of cash that could only be accessed in a temporally segregated manner. That is, the controller could be configured to not only require specific biometric identifiers but to also require that dispensation actions not occur within some predetermined period of time (such as one day or one week) of an earlier dispensation.

Pursuant to another approach, loading of the apparatus with a fresh supply of items (such as additional currency) can be rendered subject to presentation of a biometric indicator from someone other than the individual who is authorized to dispense the currency as described. For example, a bank official or other employee or representative may be the only party authorized, upon presentation of their designated biometric, to cause the apparatus housing to open in a manner that allows unfettered and uncontrolled access to the storage area. (There are various ways to facilitate such access; as one example, the housing can be configured with a clamshell form factor that is hinged along one side to thereby permit the housing to be completely opened as described. In such an embodiment, a separate latching mechanism can be used to lock the clamshell halves together. Such a separate latching mechanism can be rendered subservient to the controller or other control platform as appropriate.)

If lost or stolen, such an apparatus would of course not permit ready access to the stored contents to one who does not present a required biometric identifier. If desired, further security could include provision of an exploding ink cartridge as is sometimes used to discourage bank robberies that causes the currency or other items to be marked with a readily observable and incriminating dye upon detecting an unauthorized opening of the apparatus.

In addition, or in lieu of such an approach, the apparatus can incorporate a one-way or two-way wireless communication platform 61 as depicted in FIG. 6. This wireless transmitter 61 could utilize radio frequency signals, optical signals, or such other communication medium as may be desired and/or appropriate to a given application. Such a platform could support various security protocols. For example, the apparatus could be programmed to automatically transmit a warning or other distress signal upon detecting unauthorized or suspicious activity (for example, small accelerometers as are known in the art could be used to detect attempts to gain forced entry to the contents of the apparatus, or repeated presentation of unauthorized biometric indicators within some predetermined period of time could be used to discern manipulation by an unauthorized individual).

If desired, such an apparatus could also integrally include a location determination unit 62 (such as a global positioning system receiver or other location-determining mechanism). This, in turn, would permit the apparatus to ascertain and transmit its own relative position when also transmitting security-related or triggered signals or information as described above. Such location information could be used in other ways as well. For example, the quantity of items that may be dispensed or the particular items that may be dispensed can be further metered or conditioned as a function of location. As one simple illustration, a right hand ring finger of a given individual might permit access to a $20 bill when the apparatus presently resides within a given geographic area, but might yield a different amount (or no amount at all) when the apparatus is moved outside that given geographic area.

These teachings will facilitate other unique approaches as well. For example, upon arriving at a given country, a tourist could be provided with such an apparatus in portable form. The tourist would ultimately be responsible to compensate the party providing the apparatus for only the actual currency as was dispensed during the tourist's use of the apparatus. This could aid the tourist in avoiding unnecessary exchange rate charges and might also help tourists who are unfamiliar with bills of unusual shape, size, denomination, or appearance. As yet another example, when the apparatus permits data entry (via a dedicated keypad or via biometric-based data entry capability) the user could input a given code, such as “911,” to cause a corresponding response (such as an emergency transmission of the present location of the apparatus, marking or destruction of the contents of the apparatus, locking of the apparatus for at least a predetermined period of time such that all subsequent input during that period of time will be ignored by the apparatus, and so forth).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example, the “items” to which the user has access can comprise a consumable resource. So configured, for example, a user might select a particular quantity of gasoline to be dispensed or a particular amount of time to be rendered available on a wireless network. As another example, the “items” can comprise levels of quality of service, such that an individual can select a particular level of quality of service to be delivered with respect to a particular selected service (such as a wireless communication service).

As yet another example, these teachings can be combined with other identification and/or authorization techniques and requirements. To illustrate, an individual might be required to enter a personal identification number or other identifier into a provided keypad in order to generally authenticate themselves and/or the subsequent user and to arm the apparatus (perhaps for some short predetermined period of time) to accept and process biometric indicators as described above.

And as yet another example, these teachings can be employed in a setting that requires the contemporaneous inputting of specific biometric indicators from a plurality of users. So configured, for example, two or more persons would be required to each present one or more fingerprints at the same time (using, for example, two or more input platforms) in order to effect the desired functionality.

We claim:

1. An apparatus comprising:
a housing having at least one opening disposed therethrough;
a currency retainer disposed within the housing;
a biometric sensor;
a controller operably coupled to the biometric sensor and at least one of the opening and the currency retainer, and having:
a first mode of operation wherein a first amount of currency is dispensed from the currency retainer via the opening in response to detection of a first biometric input as sensed via the biometric sensor; and
a second mode of operation wherein a second amount of currency, which second amount of currency is different from the first amount of currency, is dispensed from the currency retainer via the opening in response to detection of a second biometric input, which second biometric input is different from the first biometric input as sensed via the biometric sensor.

2. The apparatus of claim 1 wherein the housing comprises a portable-sized housing.

3. The apparatus of claim 1 wherein the housing comprises an automated teller machine housing.

4. The apparatus of claim 1 wherein the biometric sensor comprises an asperity sensor.

5. The apparatus of claim 4 wherein the asperity sensor comprises a fingerprint sensor.

6. The apparatus of claim 5 wherein the first biometric input corresponds to a fingerprint of a first predetermined finger of a given individual.

7. The apparatus of claim 6 wherein the second biometric input corresponds to a fingerprint of a second predetermined finger of the given individual.

8. The apparatus of claim 1 wherein the controller further comprises controller means for correlating a particular detected fingerprint for a particular given individual with a particular amount of currency, such that different fingerprints for a single individual can each correspond to access to a different amount of currency.

9. A method comprising:
providing currency in a secure housing;
receiving information regarding biometric information for a given individual;
when the biometric information comprises first biometric information, providing access to a first predetermined amount of the currency;
when the biometric information comprises second biometric information, which second biometric information is different than the first biometric information, providing access to a second predetermined amount of the currency, which second predetermined amount is different than the first predetermined amount.

10. The method of claim 9 wherein providing currency in a secure housing further comprises providing currency in a secure portable housing.

11. The method of claim 9 wherein providing currency in a secure housing further comprises providing currency in a secure fixed-position housing.

12. The method of claim 9 wherein receiving information regarding biometric information for a given individual further comprises receiving asperity information as corresponds to the given individual.

13. The method of claim 12 wherein receiving asperity information as corresponds to the given individual further comprises receiving fingerprint information as corresponds to the given individual.

14. The method of claim 13 wherein the first biometric information comprises a fingerprint as corresponds to a first predetermined finger of the given individual.

15. The method of claim 14 wherein the second biometric information comprises a fingerprint as corresponds to a second predetermined finger of the given individual.

16. A method comprising:
providing a plurality of items;
receiving biometric information as corresponds to a given individual having a plurality of biometric features;
determining which of the plurality of biometric features the received biometric information corresponds to to provide an identified biometric feature;
providing limited access to at least one of the plurality of items, but less than all of the plurality of items, in a manner that corresponds to the identified biometric feature.

17. The method of claim 16 wherein providing a plurality of items further comprises providing a plurality of discrete items of currency.

18. The method of claim 17 wherein providing limited access to at least one of the plurality of items, but less than all of the plurality of items, in a manner that corresponds to the identified biometric feature further comprises providing limited access to a specific amount of currency, which specific amount of currency is less than the plurality of discrete items of currency, as corresponds to the identified biometric feature.

19. The method of claim 18 wherein:
receiving biometric information as corresponds to a given individual having a plurality of biometric features further comprises receiving fingerprint information as corresponds to a given individual having a plurality of different fingerprints as correspond to different fingers;
providing limited access to a specific amount of currency, which specific amount of currency is less than the plurality of discrete items of currency, as corresponds to the identified biometric feature further comprises providing access to a specific amount of current as corresponds to a predetermined specific finger of the given individual.

20. The method of claim 19 wherein providing a plurality of items further comprises providing the plurality of items in a housing.
